(19) United States
(12) Patent Application Publication
(10) Pub. No.: US 2016/0326000 A1
(43) Pub. Date: Nov. 10, 2016

(54) METHOD OF PREPARING ACTIVE CARBON AND ACTIVE CARBON PREPARED BY THE SAME

(71) Applicant: Korea Institute of Energy Research, Daejeon (KR)

(72) Inventors: Ha-Na Yoon, Daejeon (KR); Kyu-Nam Jung, Daejeon (KR); Jung-Joon Yoo, Daejeon (KR); Sun-Hwa Yeon, Sejong (KR); Yeong-A Lee, Daejeon (KR)

(73) Assignee: Korea Institute of Energy Research, Daejeon (KR)

(21) Appl. No.: 14/950,697

(22) Filed: Nov. 24, 2015

(30) Foreign Application Priority Data
May 7, 2015 (KR) 10-2015-0063741

(51) Int. Cl. C01B 31/10; H01M 4/587; H01G 11/26; C01B 31/08; H01G 11/36

(52) U.S. Cl. CPC C01B 31/10; C01B 31/08; H01G 11/36; H01G 11/26; H01M 4/587; C01P 2006/40; C01P 2006/12; H01M 2004/021

(57) ABSTRACT

Disclosed are a method of preparing active carbon and active carbon prepared thereby, in which carbonization and activation can be carried out through a single process, thus simplifying the preparation process and increasing energy savings and preparation efficiency.

### CROSS REFERENCE TO RELATED APPLICATION

This application claims the benefit of Korean Patent Application No. KR 10-2015-0063741, filed May 7, 2015, which is hereby incorporated by reference in its entirety into this application.

### BACKGROUND OF THE INVENTION

1. Technical Field

The present invention relates to a method of preparing active carbon and active carbon prepared thereby and, more particularly, a method of preparing active carbon, in which carbonization and activation may be performed through a single process, and active carbon prepared by the method.

2. Description of the Related Art

Supercapacitors exhibit high power density, stability, high charge/discharge efficiency, long-term reliability of 10 years or more, semi-permanent use, and rapid charge/discharge cycling characteristics, and may thus satisfy the requirements of high power sources in the fields of aerospace, transportation, machinery and renewable energy generation, to which lithium secondary batteries are difficult to apply, as well as the existing memory backup power sources.

As energy storage devices, supercapacitors have many advantages such as high power, high stability, etc., but suffer from relatively low energy density compared to other batteries or fuel cells, and thus have been utilized only in limited applications to date.

Also, supercapacitors have been initially applied in small fields, including memory backup and engine cold start. Because the performance thereof has increased and the application fields thereof have broadened, supercapacitors are currently applied in medium-sized and large fields requiring high power and stability, such as those of electric vehicles, hybrid vehicles, aircraft, smart grids, etc.

A supercapacitor typically includes two electrodes, a cathode and an anode, made from a carbon-based material, and stores electrochemical energy based on electrostatic attraction.

The electrode material for a supercapacitor cell constitutes 65% of the total material thereof. Currently, the carbon material for electrodes for industrially produced supercapacitors is active carbon. Active carbon mainly results from chemical activation following the carbonization of plants (wood, palm shell, etc.), coal/petroleum pitch, or phenol-resin. However, such materials are not readily produced domestically, and are mainly dependent on imports from foreign countries, and thus the supply thereof is limited or high costs are incurred. Additionally, when preparing active carbon using the above materials, it is difficult to control the average pore diameter and structure thereof.

In order to prepare high-quality active carbon, additional activation of the carbon material is typically carried out to form pores after carbonization. Chemical activation necessary for preparing the active carbon generally falls under two types of preparation methods, one including mixing the above material or a primary carbide thereof with a chemical agent using a mortar and pestle or a ball mill and then performing thermal treatment, and the other including dissolving a chemical agent in distilled water to prepare a solution, impregnating the carbide with the solution so that the chemical agent infiltrates the carbide, and then performing thermal treatment.

The chemical agent for use in activation is mainly exemplified by KOH. Furthermore, NaOH, K₂CO₃, Na₂CO₃, H₃PO₄ or SnCl₂ may also be used.

Thus, urgently required is the development of active carbon and methods of preparing the same, in which the material thereof may be supplied efficiently and cost-effectively, and in which the specific surface area, average pore diameter and structure thereof may be easily controlled.

Also, activation following the carbonization may be implemented at a high temperature, undesirably causing high energy consumption and complicated preparation processes, and thus more simple preparation processes are required.

### SUMMARY OF THE INVENTION

Therefore, an object of the present invention is to provide a method of preparing active carbon, in which carbonization and activation may be performed through a single process using, as a precursor, an organic compound containing a metal, thus simplifying the preparation of active carbon and reducing the preparation cost.

Another object of the present invention is to provide a method of preparing active carbon, in which the pore diameter and shape of active carbon may be controlled.

Still another object of the present invention is to provide active carbon, which may have a continuous electrical path and a rapid and effective charge transport path, and a method of preparing the same.

Yet another object of the present invention is to provide the use of active carbon as an electrode material.

In order to accomplish the above objects, the present invention provides a method of preparing active carbon, including thermally treating an organic compound containing a metal in an inert gas atmosphere.

In addition, the present invention provides active carbon, prepared by the above method.

In addition, the present invention provides an electrode material, including the above active carbon.

According to the present invention, a method of preparing active carbon enables the carbonization and activation to be carried out through a single process, thus simplifying the preparation process and increasing the preparation efficiency.

Also, according to the present invention, active carbon is prepared using, as a precursor, an organic compound containing a metal, and thus is cost-effective and is not limited as to the material supplied therefor. Furthermore, the pore diameter and shape of active carbon can be easily controlled.

Also, according to the present invention, active carbon can have a continuous electrical path and a rapid and effective charge transport path.

Also, according to the present invention, active carbon can be utilized as an electrode material in a variety of fields.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart illustrating the process of preparing a porous carbon nano-sheet according to the present invention;

FIG. 2 is a SEM image illustrating the porous carbon nano-sheet of Example 1;

FIG. 3 is a SEM image illustrating the thickness of the porous carbon nano-sheet of FIG. 2 at a magnification of 10×;

FIG. 4 is a TEM image illustrating the porous carbon nano-sheet of Example 1;

FIG. 5 is a SEM image illustrating the porous carbon nano-sheet of Example 2;

FIG. 6 is a SEM image illustrating the thickness of the porous carbon nano-sheet of FIG. 5 at a magnification of 10×;

FIG. 7 is a SEM image illustrating the porous carbon nano-sheet of Example 3;

FIG. 8 is a SEM image illustrating the thickness of the porous carbon nano-sheet of FIG. 7 at a magnification of 10×;

FIG. 9 is a SEM image illustrating the porous carbon nano-sheet of Example 4;

FIG. 10 is a SEM image illustrating the porous carbon nano-sheet of Example 5;

FIG. 11 is a SEM image illustrating the porous carbon nano-sheet of Example 6;

FIG. 12 is a graph illustrating the nitrogen gas adsorption isotherm (BET plot) of the porous carbon nano-sheet of Example 1;

FIG. 13 is a graph illustrating the nitrogen gas adsorption isotherm (BET plot) of the porous carbon nano-sheet of Example 2;

FIG. 14 is a graph illustrating the nitrogen gas adsorption isotherm (BET plot) of the porous carbon nano-sheet of Example 3;

FIG. 15 is a graph illustrating the pore size distribution (NLDFT plot) of the porous carbon nano-sheet of Example 1;

FIG. 16 is a graph illustrating the pore size distribution (NLDFT plot) of the porous carbon nano-sheet of Example 2;

FIG. 17 is a graph illustrating the pore size distribution (NLDFT plot) of the porous carbon nano-sheet of Example 3;

FIG. 18 is a graph illustrating the results of cyclic voltammetry of the electrode for an electric double layer capacitor using the porous carbon nano-sheet of Example 1; and

FIG. 19 is a graph illustrating the specific capacitance depending on changes in scan rate, calculated from the results of the cyclic voltammetry of FIG. 18.

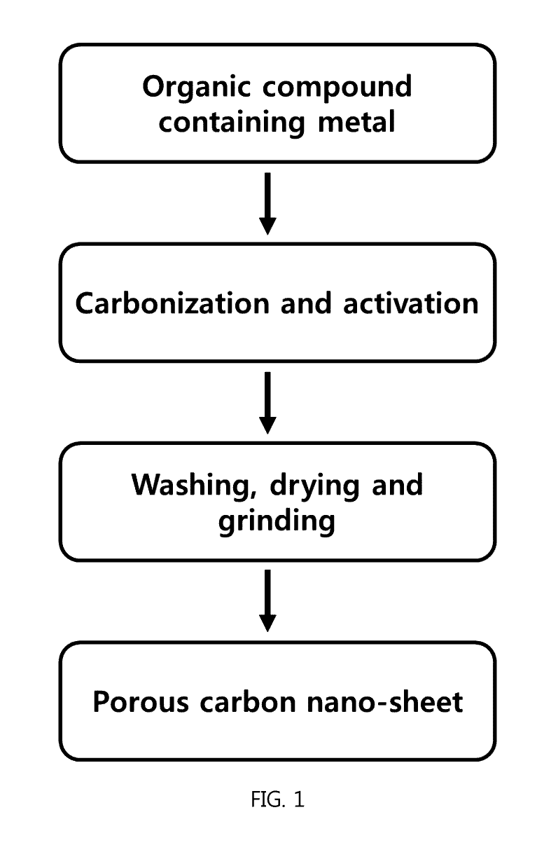

### DESCRIPTION OF THE SPECIFIC EMBODIMENTS

Hereinafter, a detailed description will be given of the present invention.

The present invention addresses a method of preparing active carbon, comprising thermally treating an organic compound containing a metal in an inert gas atmosphere.

As conventional precursors for active carbon, plant (wood, palm shell), coal/petroleum pitch, and phenol-resin have been used. However, such precursors are not readily produced domestically, and are mainly dependent on imports from foreign countries, and thus are disadvantageous in that the supply thereof is limited and high costs are incurred. Also, such precursors are difficult to control at the molecular level, making it difficult to control the shape and pore diameter of active carbon. In particular, it is impossible to provide the active carbon in the form of a nano-sheet.

Also, when the active carbon is prepared from the above precursor, additional activation following the carbonization is required, and carbonization and activation are carried out through thermal treatment at high temperatures, thus consuming large amounts of energy and complicating preparation processes.

With the goal of solving the above problems, an organic compound containing a metal is used as the precursor in the present invention.

The organic compound containing the metal is cost-effective and overcomes limitations on the supply of the precursor. As the organic compound containing the metal is variously changed in terms of the structure, molecular weight, and kind of metal thereof, it is easy to control the shape and pore diameter of the active carbon.

When the pore diameter is controlled in this way, the active carbon may have a controlled pore size so as to be suitable for use in an electrolyte, such as an aqueous electrolyte, an organic electrolyte, and an ionic liquid electrolyte. Specifically, the aqueous electrolyte, the ion size of which is relatively small, is controlled so that micropores (<2 nm) are intensively distributed, and the organic electrolyte and the ionic liquid electrolyte, the ion size of which is relatively large, are constructed so that the ratio of micropores (<2 nm), mesopores (2 to 50 nm) and macropores (>50 nm) is appropriately controlled.

In the organic compound containing the metal according to the present invention, the metal functions as an activation-inducing agent, whereby carbonization and activation may be completed through a single thermal treatment step, that is, a single process, thus simplifying the preparation process and ensuring energy savings and cost competitiveness. Furthermore, the activation-inducing agent is uniformly distributed in the course of thermal treatment, and the synthesis thereof is possible at the molecular level, thus controlling the shape and pore diameter of active carbon.

The metal includes at least one selected from the group consisting of an alkali metal, zinc, tin, iron, calcium, barium, and magnesium, and preferably includes an alkali metal.

The organic compound includes at least one selected from the group consisting of a citrate monomer, a citrate polymer, a tartrate monomer, a tartrate polymer, a gluconate monomer, a gluconate polymer, a malate monomer, and a malate polymer. Preferably, a citrate monomer or a citrate polymer is used, and particularly useful is potassium citrate tribasic monohydrate (tripotassium citrate, C₆H₅K₃O₇.H₂O).

The organic compound containing the metal may further include a monomer or a polymer of an organic compound having no metal.

The thermal treatment is performed at a temperature ranging from 600 to 1100° C. for a period of time ranging from 10 min to 10 hr in an inert gas atmosphere. In the course of such thermal treatment, both carbonization and activation of the organic compound containing the metal are carried out.

Pores are efficiently formed in the active carbon in the above temperature range, and thus electrical conductivity may increase, making it possible to use the active carbon as an electrode material. If the temperature is higher than 1100° C., the shape of the formed pores is difficult to maintain, and the yield of active carbon may decrease.

The temperature of 600 to 1100° C. may be maintained by increasing the temperature from room temperature at a heating rate of 1 to 100° C./min, and the shape, specific surface area and pore size of the active carbon may be controlled by varying the heating rate.

Within the temporal range for thermal treatment, the pores of the active carbon are efficiently formed, and thus, electrical conductivity may increase, making it possible to use the active carbon as an electrode material and adjust the shape of the active carbon.

The active carbon is prepared through thermal treatment.

After thermal treatment, washing, drying and grinding may be further implemented, thus obtaining final active carbon.

The washing process functions to remove the residual impurities from carbon particles, and the carbon particles are washed several times so as to attain a neutral pH.

To remove the water used in the washing process, drying is performed at a high temperature, preferably 80 to 200° C., for 2 to 48 hr.

However, the drying temperature and time are not limited to the above ranges, and may be variously set.

After drying, the dried carbon particles may be ground using a grinder such as a ball mill, yielding active carbon. The grinding process may be selected from among various known processes.

More specifically, the active carbon prepared by the above method may have various shapes depending on the kind of precursor, heating rate, and thermal treatment temperature. For example, the active carbon may have a spherical shape or an octahedral shape, or may be provided in the form of a nano-sheet. Preferably useful is a nano-sheet, especially a porous carbon nano-sheet.

Also, the active carbon has a specific surface area of 200 to 3000 m²/g. In particular, when the active carbon is provided in the form of a porous carbon nano-sheet, the porous carbon nano-sheet has a thickness of 1 to 500 nm.

When the shape of the active carbon is controlled, the active carbon may be applied to various fields.

Specifically, when the active carbon is provided in the form of a porous carbon nano-sheet, the thin porous carbon nano-sheet may be used as an electrode material requiring high reactivity and high power, and the thick porous carbon nano-sheet may be employed in catalyst loading or ion adsorption.

In addition, the present invention addresses active carbon prepared by the above method.

The shape and pore diameter of the active carbon may be easily controlled by varying the kind of metal and the molecular weight and structure of the organic compound containing the metal, serving as a precursor, whereby the active carbon may be variously utilized.

More specifically, the diameter of the pores may be controlled so as to form micropores, mesopores, and macropores, and the shape of the active carbon may be controlled to provide a spherical shape, an octahedral shape, and a nano-sheet.

Also, the active carbon has a specific surface area of 200 to 3000 m²/g. In particular, when the active carbon is provided in the form of a porous carbon nano-sheet, the porous carbon nano-sheet has a thickness of 1 to 500 nm.

The active carbon may be applied to a variety of fields by adjusting the shape thereof.

Specifically, when the active carbon is provided in the form of a porous carbon nano-sheet, the thin porous carbon nano-sheet may be used as an electrode material requiring high reactivity and high power, and the thick porous carbon nano-sheet may be utilized in catalyst loading or ion adsorption.

In addition, the present invention addresses an electrode material including the active carbon.

More specifically, the electrode material may be utilized for supercapacitors, electrochemical flow capacitors, catalytic carriers, molecular sieves, deodorizers, water purifiers, air purifiers, or batteries.

Below, the present invention is specified through examples.

The following examples are merely set forth to illustrate, but are not to be construed as limiting the present invention.

### Preparation of Active Carbon

### Example 1

As a precursor, 10 g of potassium citrate tribasic monohydrate (tripotassium citrate, C₆H₅K₃O₇.H₂O, Sigma Aldrich) was placed in an alumina tube and purged with an argon atmosphere. Thereafter, heating from room temperature to 850° C. at a rate of 14° C./min was carried out, followed by reaction for 1 hr at that temperature.

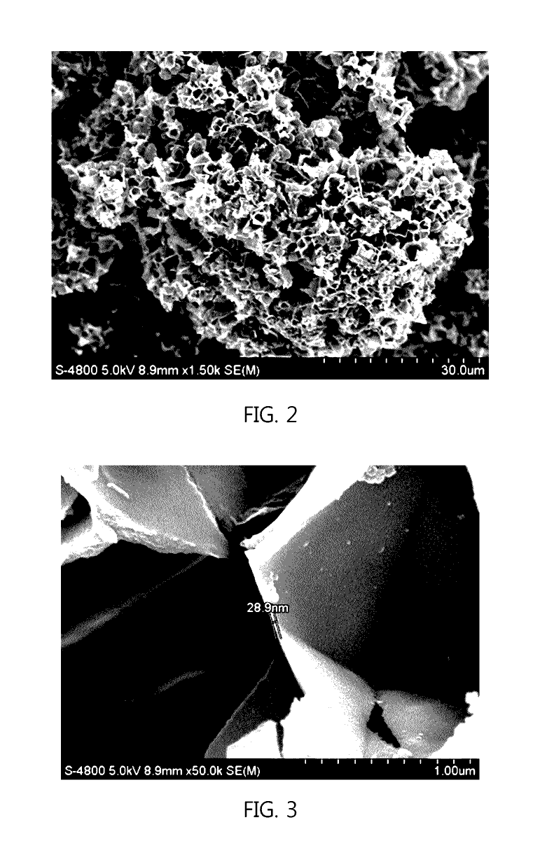

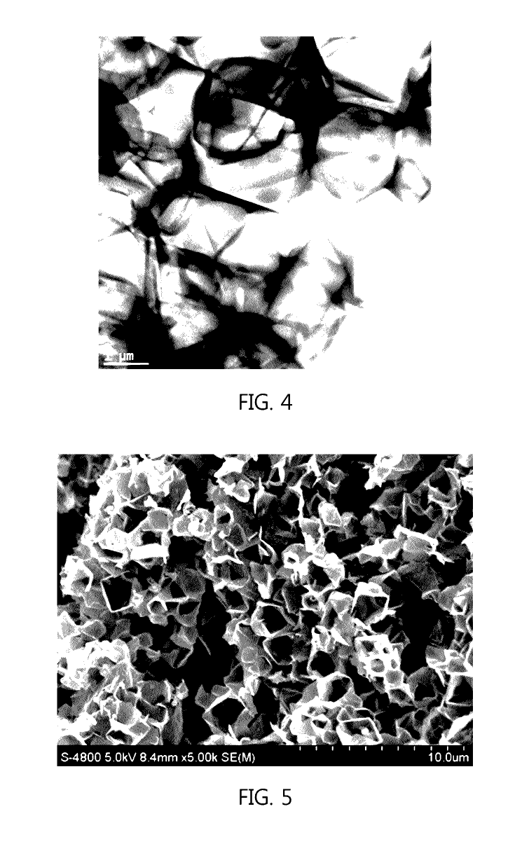

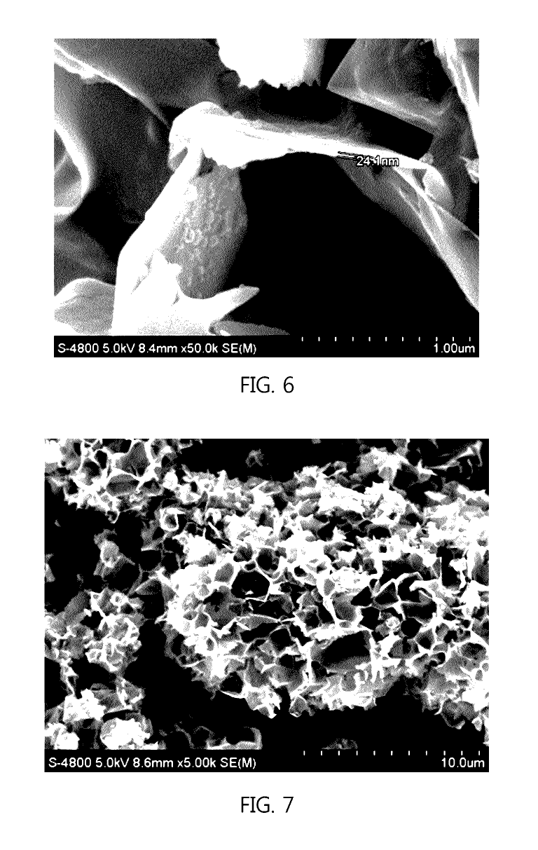

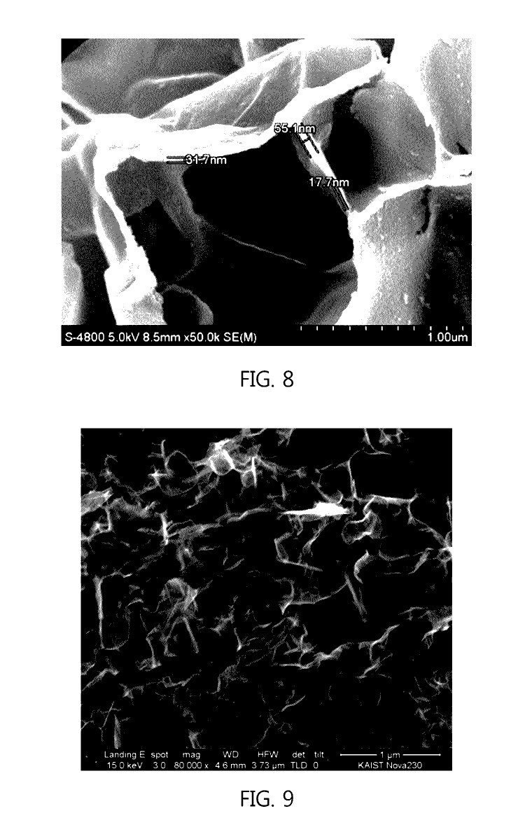

Thereafter, washing for removing the residual impurities from carbon particles was repeated several times so as to attain a neutral pH, and a solid filtrate was filtered using a filter. The solid filtrate was dried at 120° C. for 12 hr and was then ground using a mortar and pestle, thus preparing active carbon in nano-sheet form, namely a porous carbon nano-sheet (FIGS. 2 to 4).

The shape of the porous carbon nano-sheet was analyzed using SEM (Scanning Electron Microscopy, Hitachi S-4800 and FEI Nova230) and 300 kV FE-TEM (Field Emission-Transmission Electron Microscopy, Tecnai G2 F30).

### Examples 2 to 6

Porous carbon nano-sheets were prepared in the same manner as in Example 1, with the exception that different conditions, as shown in Table 1 below, were applied.

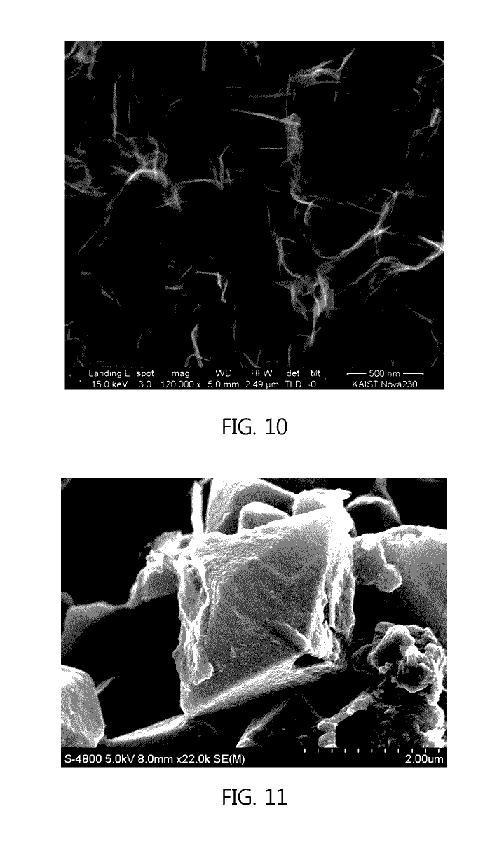

TABLE 1

| | | | Reaction | |
|---|---|---|---|---|
| | | Heating rate | temperature | |
| | Precursor | (° C./min) | (° C.) | Shape |
| Ex. 1 | C₆H₅K₃O₇•H₂O | 14 | 850 | FIGS. 2 to 4 |
| Ex. 2 | C₆H₅K₃O₇•H₂O | 5 | 850 | FIGS. 5 & 6 |
| Ex. 3 | C₆H₅K₃O₇•H₂O | 2 | 850 | FIGS. 7 & 8 |
| Ex. 4 | C₆H₅Na₃O₇•2H₂O | 5 | 850 | FIG. 9 |
| Ex. 5 | C₆H₅Na₃O₇•2H₂O | 5 | 900 | FIG. 10 |
| Ex. 6 | C₆H₅K₃O₇•H₂O, | 5 | 850 | FIG. 11 |
| | C₆H₅FeO₇•H₂O | | | |
| | (0.001 mol) | | | |

### Test Example 1

### Analysis of Components of Porous Carbon Nano-Sheet

The components of the porous carbon nano-sheets of Examples 1 to 3 and 6 were analyzed using SEM-EDS (SEM-Energy Dispersive X-ray Spectroscopy, Hitachi S-4800). The results are shown in Table 2 below.

TABLE 2

Atomic (%)

| | C | O | K | Fe |
|---|---|---|---|---|
| Ex. 1 | 85.88 | 14.02 | 0.1 | — |
| Ex. 2 | 87.02 | 12.69 | 0.29 | — |
| Ex. 3 | 90.54 | 9.39 | 0.07 | — |
| Ex. 6 | 84.5 | 14.63 | 0.42 | 0.45 |

In order to prepare high-performance active carbon, the carbon content is preferably set to 80% or more. As is apparent from the results of Table 2, the porous carbon nano-sheets of Examples 1 to 3 and 6 had a carbon content of 80% or more.

### Test Example 2

### Measurement of Properties of Porous Carbon Nano-Sheet

The porous carbon nano-sheets of Examples 1 to 3 and 6 were measured for specific surface area based on BET (Brunauer-Emmett-Teller) theory, total pore volume, and average pore diameter. The results are shown in Table 3 below.

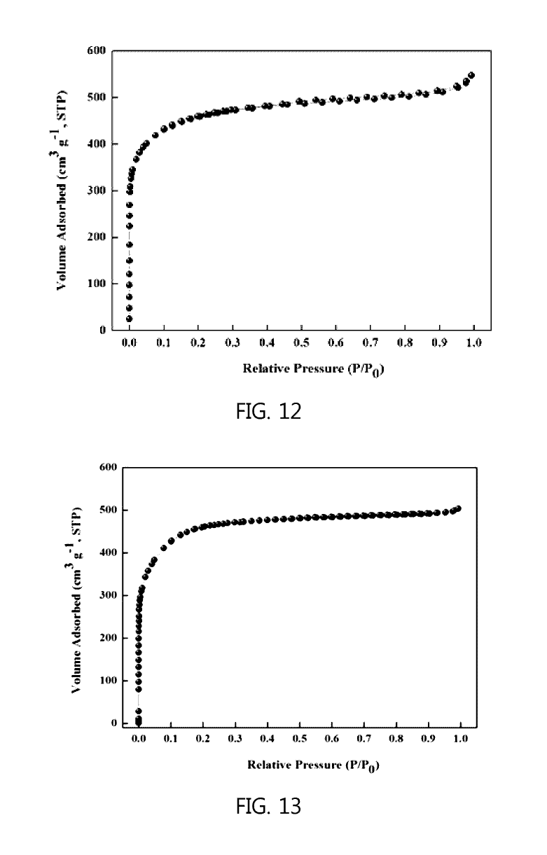

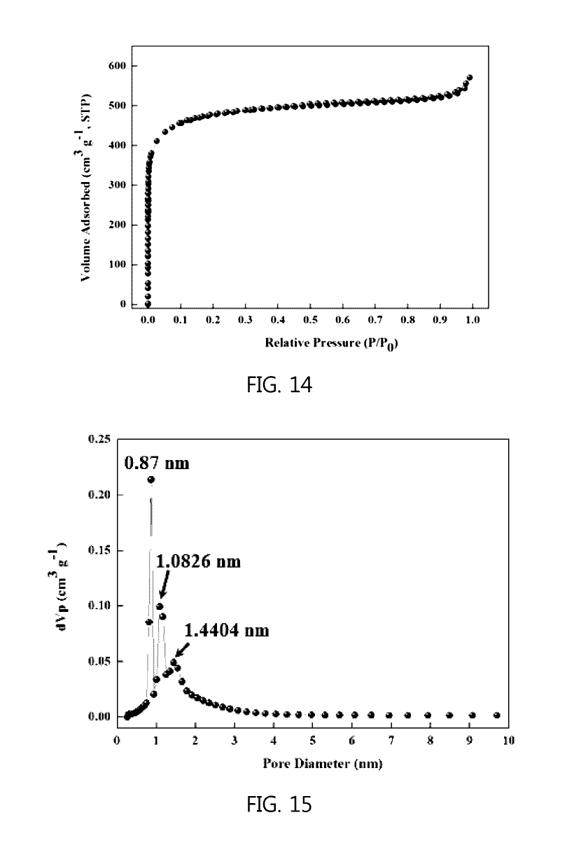

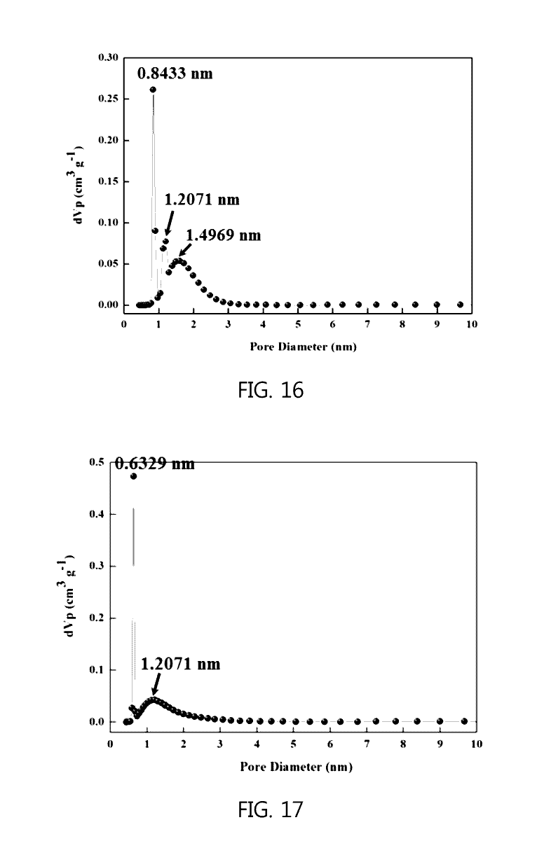

Also, nitrogen (N₂) gas absorption/desorption isotherms (FIGS. 12 to 14) were measured, and the pore size distributions (FIGS. 15 to 17) were measured through NLDFT (Non-Local Density Functional Theory).

The BET specific surface area and the pore size distribution were measured using a BELSORP max system in liquid nitrogen (77K).

TABLE 3

| | Specific surface | Total pore | Average pore |
|---|---|---|---|
| | area (m²/g) | volume (cm³/g) | diameter (nm) |
| Ex. 1 | 1683.6 | 0.8472 | 2.0129 |
| Ex. 2 | 1736.8 | 0.7779 | 1.7915 |
| Ex. 3 | 1808.3 | 0.8803 | 1.9472 |
| Ex. 6 | 612.1 | 0.4414 | 2.8847 |

As is apparent from the results of Table 3, the active carbon according to the present invention and, more particularly, the porous carbon nano-sheet, had high specific surface area, and the pore size and distribution thereof could be controlled by adjusting the precursor, heating rate, and reaction temperature.

### Test Example 3

### Measurement of Cyclic Voltammetry of Porous Carbon Nano-Sheet

Cyclic voltammetry (CV) of the porous carbon nano-sheet of Example 1 was carried out.

Specifically, a slurry was prepared by mixing 80 wt % of the porous carbon nano-sheet of Example 1 as an active material, 10 wt % of a carbon black conductor, and 10 wt % of a polyvinylidene fluoride (PVdF) binder.

The slurry was applied to a thickness of about 100 μm on a piece of aluminum foil having a thickness of 20 μm, and then dried at 120° C. for 10 hr. Thereafter, coin electrodes having a diameter of 14 mm were manufactured, and were disposed to face each with an insulating separator interposed therebetween, yielding a coin-type cell.

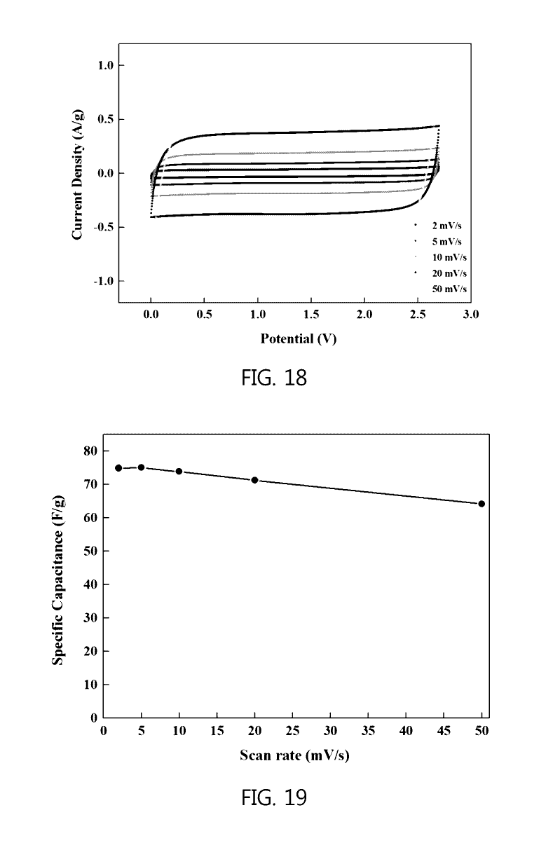

The electrodes were subjected to full cell electrode testing using a 1M TEABF₄ organic electrolyte in the presence of an acetonitrile solvent, whereby a cyclic voltammetry measurement thereof was made (FIG. 18).

The specific capacitance values depending on changes in the scan rate, calculated through the cyclic voltammetry, were 75 F/g at 2 mV/s, 75 F/g at 5 mV/s, 74 F/g at 10 mV/s, and 71 F/g at 20 mV/s. Even when the scan rate was increased, stable specific capacitance was ensured (FIG. 19).

According to the present invention, active carbon can be prepared by subjecting an organic compound containing a metal, as a precursor, to a single thermal treatment process, in which both carbonization and activation occur together, without an additional activation process.

The active carbon thus prepared has a high specific surface area, and can ensure a continuous electrical path and a rapid and effective charge transport path, and is thus useful as an electrode material, especially as an electrode material for a supercapacitor.

Although the preferred embodiments of the present invention have been disclosed for illustrative purposes, those skilled in the art will appreciate that various modifications and other equivalent embodiments are possible from the embodiments. Therefore, the technical scope of the present invention should be defined by the technical spirit of the claims.

What is claimed is:

1. A method of preparing active carbon, comprising thermally treating an organic compound containing a metal in an inert gas atmosphere.

2. The method of claim 1, wherein the metal comprises at least one selected from the group consisting of an alkali metal, zinc, tin, iron, calcium, barium, and magnesium.

3. The method of claim 2, wherein the metal comprises an alkali metal.

4. The method of claim 1, wherein the organic compound comprises at least one selected from the group consisting of a citrate monomer, a citrate polymer, a tartrate monomer, a tartrate polymer, a gluconate monomer, a gluconate polymer, a malate monomer, and a malate polymer.

5. The method of claim 1, wherein the organic compound containing the metal further comprises a monomer or a polymer of an organic compound having no metal.

6. The method of claim 1, wherein the thermally treating is performed at a temperature of 600 to 1100° C.

7. The method of claim 6, wherein the temperature of 600 to 1100° C. is obtained by increasing a temperature from room temperature at a heating rate of 1 to 100° C./min.

8. The method of claim 1, wherein the thermally treating is performed for 10 min to 10 hr.

9. The method of claim 1, further comprising performing washing, drying, and grinding, after the thermally treating.

10. The method of claim 1, wherein the active carbon is provided in a form of a porous carbon nano-sheet.

11. The method of claim 10, wherein the porous carbon nano-sheet has a thickness of 1 to 500 nm.

12. The method of claim 1, wherein the active carbon has a specific surface area of 200 to 3000 m²/g.

13. Active carbon, prepared by the method of claim 1.

14. The active carbon of claim 13, wherein the active carbon is provided in a form of a porous carbon nano-sheet.

15. The active carbon of claim 14, wherein the porous carbon nano-sheet has a thickness of 1 to 500 nm.

16. The active carbon of claim 13, wherein the active carbon has a specific surface area of 200 to 3000 m²/g.

17. An electrode material, comprising the active carbon of claim 13.
